(19) United States
(12) Patent Application Publication
(10) Pub. No.: US 2001/0025873 A1
(43) Pub. Date: Oct. 4, 2001

(54) Soldering method for soldering electronic parts and soldering apparatus therefor

(76) Inventors: Soshi Tanaka, Chiba (JP); Takeshi Ambe, Chiba (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/778,806

(22) Filed: Feb. 8, 2001

(30) Foreign Application Priority Data
Feb. 9, 2000 (JP) P2000-031638

(51) Int. Cl. B23K 31/02; B23K 37/04

(52) U.S. Cl. 228/180.21; 228/180.22; 228/49.1; 228/49.5

(57) ABSTRACT

The heating surface of an iron member is contacted to the upper surface of an electronic part such as a semiconductor chip to be mounted on a wiring substrate. Then solder electrode sections (solder balls) on the electronic part are dissolved so that the electronic part is soldered to a cupper foil pattern on the wiring substrate. And only the electronic parts necessary to be soldered are heated at a uniform heating temperature without influencing the periphery. Moreover, the iron member is moved by a moving head (iron head), and the wiring substrate is placed on a moving table to be moved. A semiconductor chip is mounted at a predetermined position on the wiring substrate by the movement of the iron member and the semiconductor substrate. The iron member is provided with a function of holding the semiconductor chip by attracting it, and thus the iron member has a function of a soldering apparatus and a function of a chip mounter.

### BACKGROUND OF THE INVENTION

1. Field of the Invention

The present invention relates to a soldering method for soldering electronic parts of ball grid array (BGA) type and chip size packages (CSP) type on a wiring substrate, and soldering apparatus for such soldering method.

2. Description of the Related Art

There has conventionally been known a soldering method in which warm air (hot air) or an infrared ray (far-infrared ray) is used as a heating means for dissolving solder in a spot re-flow processing by heating a part of a wiring substrate for mounting many electronic parts on the wiring substrate.

That is, the spot re-flow processing is to perform the soldering process of only the regions at which electronic parts necessary to be soldered by means of heating among various electronic parts disposed on the wiring substrate by supplying the warm air or the infrared ray locally to the wiring substrate.

However, the spot re-flow processing using the warm air or the infrared ray as the heating means has the following defects when the soldering process by spot heating for a short time is attempted.

(1) For example as shown in FIG. 8, in case of soldering a semiconductor chip 10 of a BGA type on a wiring substrate 20, a heating process using a warm air or an infrared ray generates the dispersion of the temperatures of each solder ball 12 within a range of the spot heating process depending on an inner structure of the semiconductor chip 10, the differences of the shapes of copper foil patterns 22 of the wiring substrate 20, the distribution of parts around the region or the like.

Consequently, for example as shown in FIG. 8, low temperature section and high temperature section are produced in the range of the spot heating, which generates soldering failures such as half-dissolving and voids.

For example, as shown in FIG. 9, in the high temperature section, copper foils 14 and 24 on soldering surfaces of the semiconductor chip 10 and the wiring substrate 20, respectively, dissolve into the solder ball 12 as indicated by arrows A (a phenomenon of dissolution of the copper into the solder), which deteriorates the soldering strength.

Moreover, for example, as shown in FIG. 10, a flux component included in the solder is not completely evaporated in the low temperature section, and gas bubbles 30 remain in the solder as voids.

Furthermore, the dissolving between a printed creamy solder 32, and the solder ball 12 becomes imperfect (half dissolved state) in the low temperature section, for example, as indicated by arrows B in FIG. 11, which deteriorates soldering strength.

(2) Furthermore, for example as shown in FIG. 12, distortion such as a bend is generated in the wiring substrate 20 or the semiconductor chip 10 owing to the temperature difference between heated parts and the periphery of the heated parts in the spot re-flow processing using the warm air or the infrared ray as the heating means, and thereby the exfoliation of the solder balls 12 (e.g. the solder ball 12A shown in FIG. 12) and the collapsing of them (e.g. the solder ball 12B shown in FIG. 12) are occurred.

By the way, Japanese Laid-Open Patent Publication HEI 9-92682 discloses a method and an apparatus for a soldering process, in which an iron member is provided for holding a back surface of an electronic part such as a semiconductor chip by attracting it, and heat of the heated iron member is conducted to a solder electrode section through the back surface of the electronic part, and thereby the electronic part is soldered on a circuit pattern on a wiring substrate. And further, it is described in the publication that a position of the electronic part attracted by the iron member to be held is controlled by a moving means provided to the iron member for being positioned to the cupper foil pattern of the wiring substrate. That is, the described configuration disposes a positioning means for positioning the electric part to the wiring pattern of the wiring substrate on the side of the iron member in either cases of a batch system in which the wiring substrate is fixed and a line system in which the wiring substrate is conveyed at a predetermined speed by a conveyer.

However, if the positioning means for positioning electronic parts to the wiring substrate is provided on the side of the iron member that attracts the electronic parts for holding them, the configuration becomes complicated and large in size. If the iron member for heating the electronic parts is complicated and large in size, the conducting efficiency of the heat to be conducted from the iron member to the solder electrode section through the electronic parts is worse, and consequently there is some probability that the solder electrode sections of the electronic part cannot uniformly be heated.

### SUMMARY OF THE INVENTION

An object of the present invention is to provide a soldering method capable of performing an appropriate spot re-flow processing and a soldering apparatus for soldering a solder electrode section of an electronic part to a wiring pattern of a wiring substrate in a good condition.

For attaining the aforesaid object, the present invention has a feature of: performing alignment of a solder electrode section of an electronic parts and a wiring pattern of a wiring substrate by relatively moving a moving table in a two dimensional plane with the wiring substrate placed on the moving table and an iron member for holding the electronic part by attracting it, the iron member being capable of performing an up-down moving against the wiring substrate and capable of rotating around an axis of the up-down moving; and soldering the solder electrode section to the wiring pattern of the wiring substrate by contacting the solder electrode section to the wiring pattern and then heating the iron member to dissolve the solder electrode section of the electronic part.

Moreover, a soldering apparatus of the present invention has a feature that comprises: a moving table movable in a two dimensional plane with a wiring substrate placed on the movable table; an iron member including holding means for holding an electronic part by attracting it and heating means for heating the electronic part, the iron member being capable of performing an up-down moving against the wiring substrate and capable of rotating around an axis of the up-down moving; and alignment means for performing an alignment between a solder electrode section of the electronic part and a wiring pattern on the wiring substrate by a relative movement between the moving table and the iron member, wherein the solder electrode section is contacted to the wiring pattern, and the iron member is heated, and then the solder electrode section of the electronic part is diffused to be soldered to the wiring pattern.

According to the soldering method of the present invention, the improvement of the heat conductivity from the iron member to the solder electrode section of the electronic part is attained, and the uniformness of the temperature of a solder bump of a heated electronic part can be attained.

Furthermore, according to a soldering apparatus of the present invention, positioning means of the wiring substrate of the electronic part to the wiring pattern is shared by the moving table movable in a two dimensional horizontal plane and being provided on the wiring substrate side and means for an up-down movement and rotation being provided on the iron member side. Consequently, the improvement of the heat conductivity from the heated iron member to the solder electrode section of the electronic part is attained, and the uniformness of the temperature at a solder electrode section of the electronic part can be attained.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is an explanatory view showing a basic configuration of a soldering apparatus for realizing a soldering method according to an embodiment of the present invention;

FIG. 2 is an explanatory view showing the scheme of a concrete apparatus used for performing a soldering method according to the embodiment of the present invention;

FIGS. 3A-3D are explanatory views showing an order of spot heating processing according to an embodiment of the present invention;

FIG. 4 is a graph showing an example of a result of a measurement of time from heating to cooling in case of soldering in conformity with a soldering method of an embodiment of the present invention;

FIG. 5 is a graph showing an example of a result of a measurement of time from heating to cooling in case of the soldering by the heating with a far-infrared ray under the condition similar to the example shown in FIG. 4;

FIG. 6 is a graph showing an example of a result of a measurement of time from heating to cooling in case of the soldering by the heating with warm air under the condition similar to the example shown in FIG. 4;

FIG. 7 is an explanatory view showing the scheme of a concrete apparatus used in a soldering method according to another embodiment of the present invention;

FIG. 8 is an explanatory view showing the ununiformity of temperature generated in conformity with a conventional heating method;

FIG. 9 is an explanatory view showing a dissolution phenomenon of a copper foil that happens at the time of performing a conventional heating method;

FIG. 10 is an explanatory view showing a phenomenon of remaining gas bubbles that happens at the time of performing a conventional heating method;

FIG. 11 is an explanatory view showing an incomplete dissolution phenomenon of solder that happens at the time of performing a conventional heating method; and

FIG. 12 is an explanatory view showing an exfoliation phenomenon and a collapsing phenomenon of solder balls owing to the warp of a wiring substrate or the like that happens at the time of performing a conventional heating method.

### DESCRIPTION OF THE PREFERRED EMBODIMENTS

Hereinafter, embodiments of a soldering method according to the present invention are described.

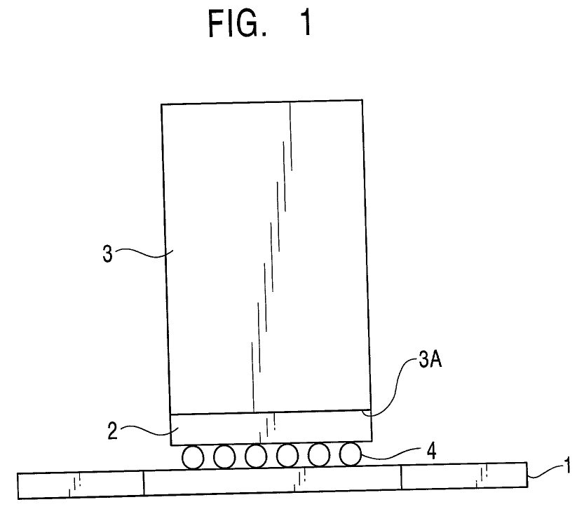

FIG. 1 is an explanatory view showing a basic configuration of a soldering apparatus for realizing the soldering method according to an embodiment of the present invention. As shown in the figure, in the soldering method of the present embodiment, a heating surface 3A of an iron member 3 is contacted to an upper surface of an electronic part (such as a semiconductor chip) 2 placed on a wiring substrate 1 to dissolve solder electrode sections (solder balls) 4 of the electronic part 2 for soldering the electronic part 2 to a cupper foil pattern on the wiring substrate 1.

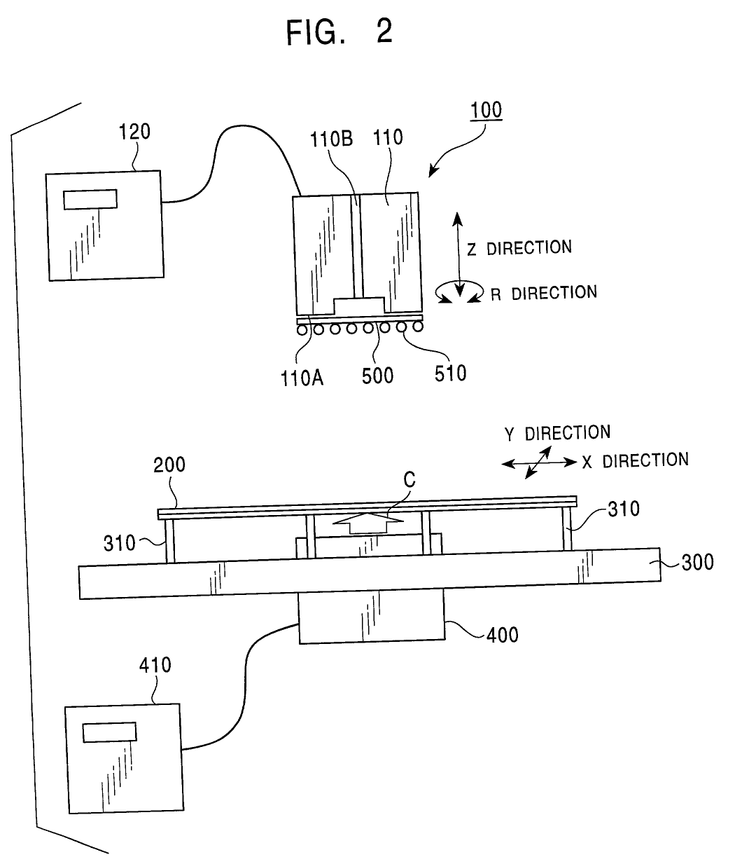

Hereinafter, a concrete configuration of the embodiment is described. FIG. 2 is an explanatory view showing the scheme of a concrete soldering apparatus used for performing the soldering method according to the present embodiment.

At first, an iron head (moving head) 100 has an iron member 110 made of steel equipped with a heating surface 110A contacting an upper surface of a semiconductor chip 500 such as ball grid array (BGA) type and chip size package (CSP) type, and the iron head 100 is constructed so that it is moved in an up-down direction (direction of an arrow Z) and a rotation direction (direction of an arrow R) without showing a moving mechanism in FIG. 2. A heater (not shown in the figure) for heating the iron member 110 is controlled by a temperature regulator 120 to control the temperature of the heating surface 110A at an arbitrary temperature.

Moreover, an attraction air passage 110B of the iron member 110 for holding the upper surface of the semiconductor chip 500 is connected with a attraction apparatus (not shown). That is, in the apparatus of the example, the iron head 100 has both functions of a heater and a chip mounter for positioning the semiconductor chip 500 to a wiring substrate 200 and placing it at that position, and thus the iron head 100 has a function to pick up a semiconductor chip 500 from a chip tray or the like to mount the picked semiconductor chip at a predetermined position of the wiring substrate 200.

Incidentally, the mounting position of the semiconductor chip 500 by such an iron head 100 is controlled as follows. For example, a CCD camera takes images of an outward form and positions of electrodes of the semiconductor chip 500, and the angles or the like of the iron head 100 are corrected by the use of the taken images similarly to a conventional chip mounter.

On the other hand, the wiring substrate 200 for mounting the semiconductor chip 500 is held above a moving table 300 with a supporting member 310. The moving table 300 is moved in two-dimensional directions (a direction of an arrow X and a direction of an arrow Y) by a moving mechanism.

The semiconductor chip 500, which is conveyed in a state being held by the iron head 100 as a chip mounter, is positioned to the wiring substrate 200 held by the moving table 300 to be mounted on the wiring substrate 200. The semiconductor chip 500 is provisionally held by means of, for example, the adhesive force of a creamy solder, if the semiconductor chip 500 is in a state before being soldered.

Then, a solder ball 510 is dissolved by the heat conducted through the semiconductor chip 500 from the iron member 110 that is initially heated. Thus the semiconductor chip 500 is soldered to the wiring substrate 200. The spot heating process can thus be performed.

Furthermore, a pre-heating block 400 is provided on the opposite side to the wiring substrate 200 held by the moving table 300. The pre-heating block 400 is for pre-heating the wiring substrate 200 before the aforesaid spot heating process by the iron head 100. The preheating block 400 is disposed at a position opposing the iron head 100 with the wiring substrate 200 between them.

The pre-heating block 400 heats a region to which the spot heating process is performed by the iron head 100 of the wiring substrate 200 to a predetermined temperature by supplying, for example, warm air or an infrared ray to a back surface of the wiring substrate 200 as shown by an arrow C.

Then, the following processes are performed. That is, a part of the wiring substrate 200 is selected by the movement of the wiring substrate 200 by the moving table 300. The selected part of the wiring substrate 200 is pre-heated by the pre-heating block 400, and the mounting process of the semiconductor chip 500 and the spot heating process of the mounted semiconductor chip 500 are performed by the iron head 100.

Incidentally, the temperature of the pre-heating process by the pre-heating block 400 is controlled by a temperature regulator 410, and thereby the temperature of the pre-heating can arbitrarily be controlled.

As described above, the apparatus of the example performs the pre-heating of the wiring substrate 200 by using warm air or an infra-red ray, which is used in the conventional spot re-flow processing, and then performs the final spot re-flow processing for dissolving the solder balls by the heating from the semiconductor chip 500 side by the iron head 100. Consequently, the apparatus of the example can remove the aforesaid faults in the case where the spot re-flow processing is performed by the use of only the warm air or the infra-red ray, and can attain the reduction of the time of the spot heating process by the iron head 100, and thereby can perform the spot heating processing by uniform temperature for a short time.

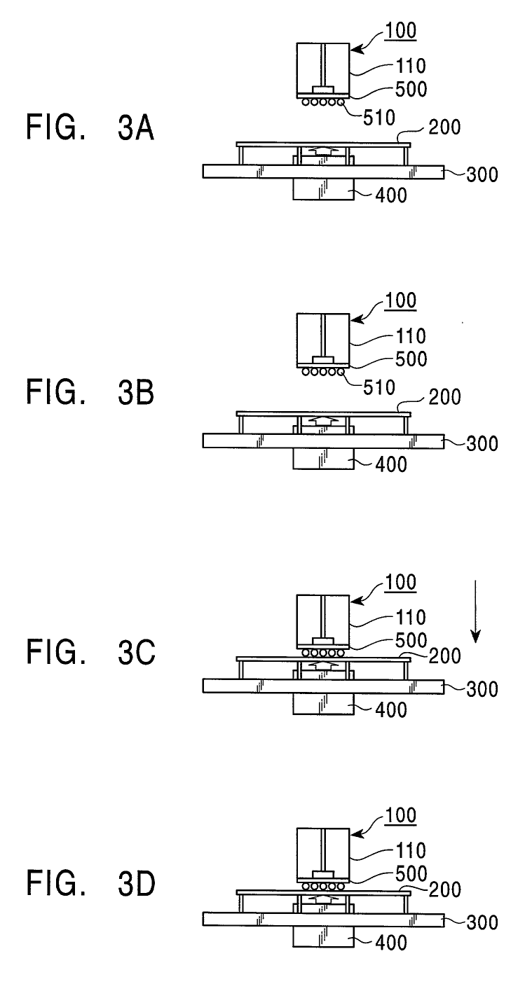

FIGS. 3A-3D are explanatory views showing an order of spot heating process using the apparatus configured like above. At first, as shown in FIG. 3A, the semiconductor chip 500 is held by the iron head 100 by being attracted by the iron head 100. Next, as shown in FIG. 3B, the semiconductor chip 500 is pre-heated by the preheating temperature of the iron member 110, and the wiring substrate 200 is pre-heated by the pre-heating block 400. Next, as shown in FIG. 3C, iron head 100 is moved to the wiring substrate 200 side, and the semiconductor chip 500 is positioned to be located at a predetermined position of the wiring substrate 200. After that, as shown in FIG. 3D, the temperature of the iron member 110 is raised, and the solder balls 510 are dissolved by the heat conducted through the semiconductor chip 500. And thereby, the copper foil electrode sections of the semiconductor chip 500 and the copper foil pattern of the wiring substrate 200 are soldered with the solder balls 510. After that, the heating by the iron head 100 and the pre-heating block 400 is stopped, and the cooling of the semiconductor chip 500 and the wiring substrate 200 is conducted.

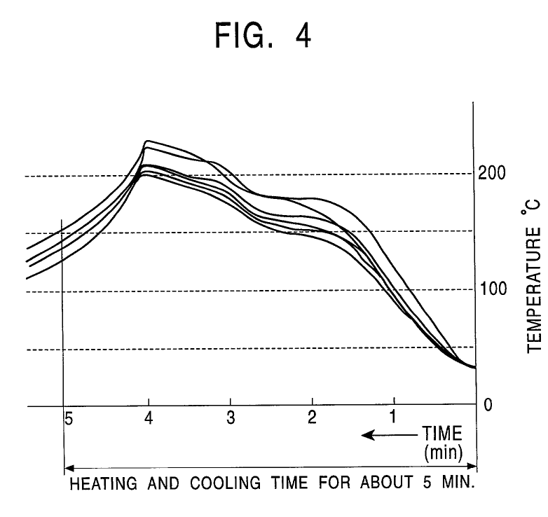

FIG. 4 is a graph showing an example of a result of a measurement of time from heating to cooling in case of soldering in conformity with the soldering method of the embodiment.

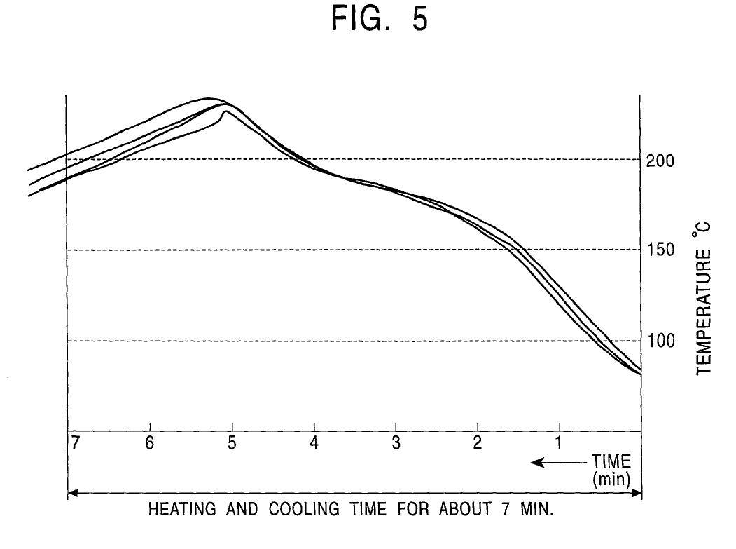

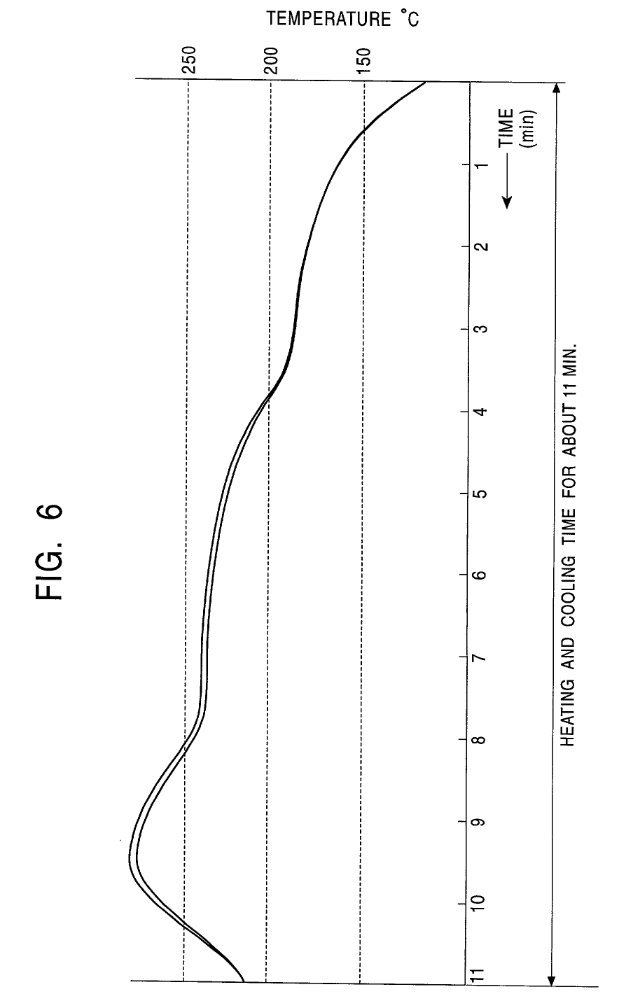

On the other hand, FIG. 5 is a graph showing an example of a result of a measurement of time from heating to cooling in case of the soldering by the heating with a far-infrared ray under the condition similar to the example shown in FIG. 4, and FIG. 6 is a graph showing an example of a result of a measurement of time from heating to cooling in case of the soldering by the heating with warm air under the condition similar to the example shown in FIG. 4.

As shown in the figures, the time necessary from the heating to the cooling in the case of the use of the far-infrared ray heating takes about seven minutes, and the time necessary from the heating to the cooling in the case of the use of the warm air heating takes about eleven minutes. However, the time necessary from the heating to the cooling in the case of the use of the iron heating of the present embodiment takes about five minutes. Thereby the shortening of working time can be attained.

Incidentally, in the above description, an example of an apparatus performing automatically soldering is described, however, the present invention may be embodied so that the soldering is performed by heating with a manually handled iron.

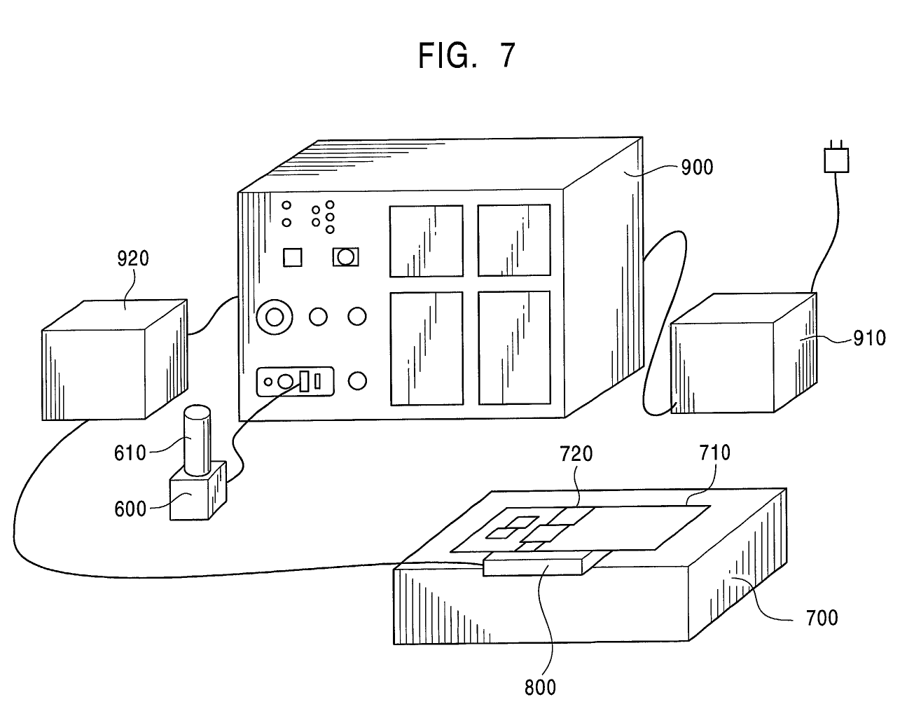

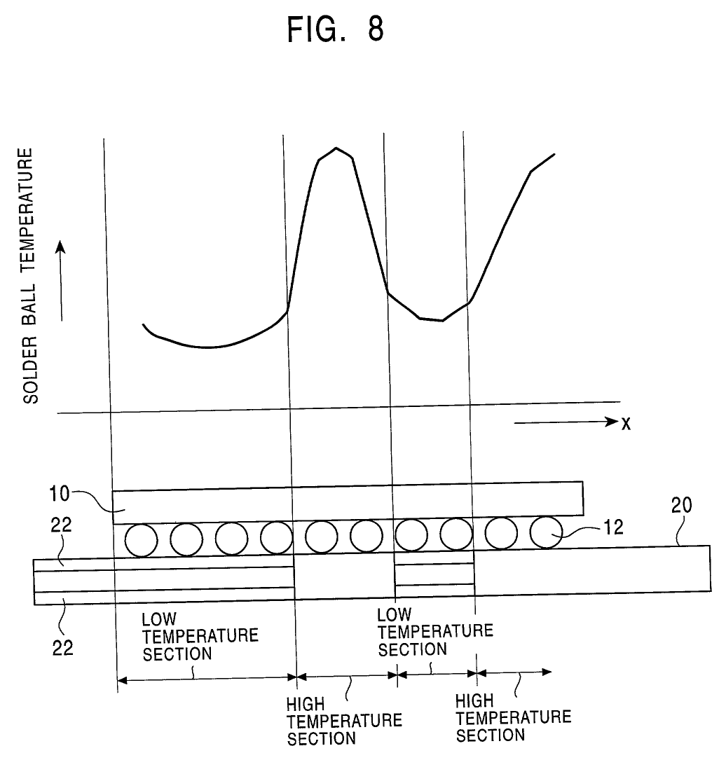

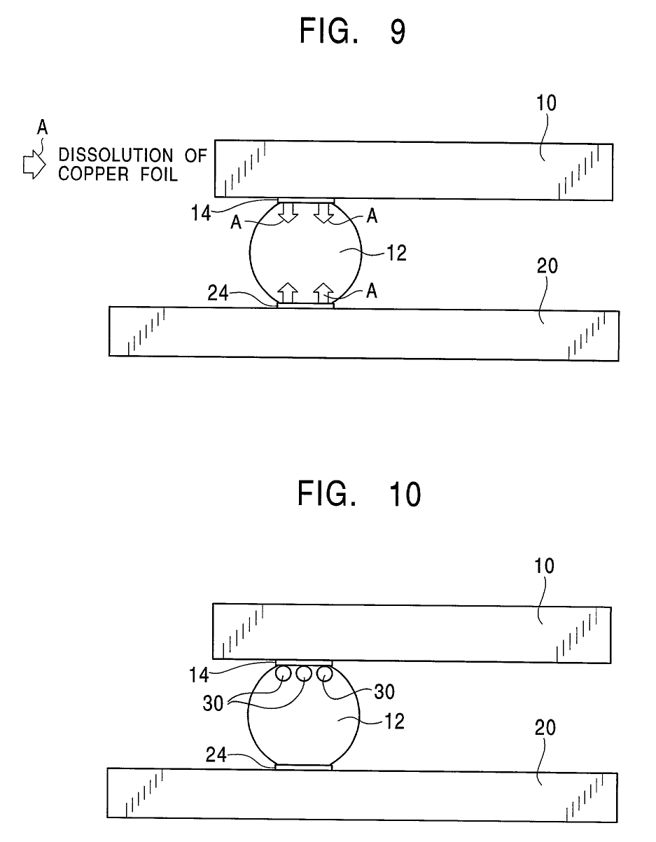

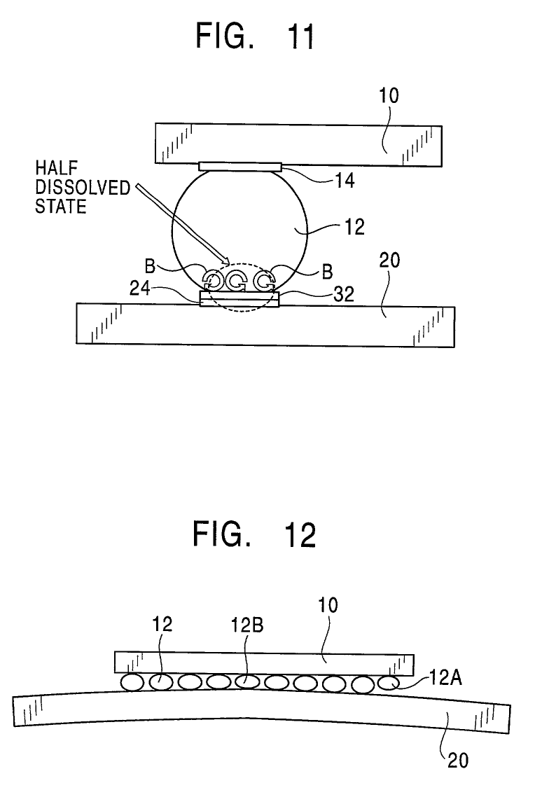

FIG. 7 is an explanatory view showing the scheme of an apparatus for heating with such a manually handled iron.

The apparatus is provided with a handy type iron member 600, a pre-heating block 800 for pre-heating a lower surface of a wiring substrate 710 disposed on a substrate supporting table 700, a temperature regulator 900 for regulating the temperatures of the iron member 600 and the preheating block 800, a converter 910 for obtaining a power source for the temperature regulator 900, and a transformer 920 for supplying power to the pre-heating block 800.

A handle section 610 is formed on the upper portion of the iron member 600, and a user can perform soldering by applying a heating surface (not shown in FIG. 7) formed on the bottom surface of the iron member 600 to the upper surface of a semiconductor chip 720 placed on the wiring substrate 710 by holding the handle section 610 with a hand.

Thus the soldering with a cheaper configuration can be performed.

Moreover, in the aforesaid description, a method and an apparatus in which a semiconductor chip is soldered on a wiring substrate have been described, the method according to the present invention can be used in an opposite case where a semiconductor chip soldered to a wiring substrate is detached from the wiring substrate.

That is, it is possible to detach a semiconductor chip from a wiring substrate in conformity with the opposite order shown in FIG. 3. That is, the semiconductor chip soldered to the wiring substrate is heated by an iron member to dissolve the solder, and then the semiconductor chip is held by an iron head by being attracted for detaching the semiconductor chip from the wiring substrate.

Moreover, it is also possible to handle manually the iron member in such a configuration shown in FIG. 7 to dissolve the solder, and to detach the semiconductor chip from the wiring substrate.

Furthermore, in the aforesaid description, the description has been given the examples in which a semiconductor chip is used as an electronic part to be soldered to a wiring substrate, however, the present invention can be applied to a soldering method for soldering the other electronic parts.

Although the invention is described in its preferred form with a certain degree of particularity, obviously many changes and variations are possible therein. It is therefore to be understood that the present invention may be practiced than as specifically described herein without departing from scope and the sprit thereof.

What is claimed is:

1. A soldering method comprising the steps of:
performing alignment of a solder electrode section of an electronic part and a wiring pattern of a wiring substrate by relatively moving a moving table in a two dimensional plane with said wiring substrate placed on said moving table and an iron member for holding said electronic part by attracting it, wherein said iron member being capable of performing up and down moving against said wiring substrate and capable of rotating around an axis of the up and down moving; and
soldering said solder electrode section to said wiring pattern by contacting said solder electrode section to said wiring pattern and then heating said iron member to dissolve said solder electrode section of said electronic part.

2. The soldering method according to claim 1, wherein
a temperature of a heating surface of said iron member is adjustable to an arbitrary temperature.

3. The soldering method according to claim 1, wherein said method further comprising a step of:
performing pre-heating said wiring substrate from its back surface before said soldering by said iron member.

4. The soldering method according to claim 3, wherein
a temperature of said preheating is adjustable to an arbitrary temperature.

5. The soldering method according to claim 1, wherein
said iron member is manually handled to move, and
said soldering is performed by contacting a heating surface of said iron member with an upper surface of said electronic part.

6. A soldering apparatus comprising:
a moving table movable in a two dimensional plane with a wiring substrate placed on said movable table;
an iron member including holding means for holding an electronic part by attracting it and heating means for heating said electronic part, wherein said iron member being capable of performing up and down moving against said wiring substrate and capable of rotating around an axis of the up and down moving; and
alignment means for performing alignment between a solder electrode section of said electronic part and a wiring pattern on said wiring substrate by relative movement between said moving table and said iron member, wherein
said solder electrode section is contacted to said wiring pattern, and said iron member is heated, and then said solder electrode section of said electronic part is diffused to be soldered to said wiring pattern.

7. The soldering apparatus according to claim 6, further comprising
means for adjusting a temperature of a heating surface of said iron member to an arbitrary temperature.

8. The soldering apparatus according to claim 6, further comprising
means for performing pre-heating said wiring substrate from its back surface before said soldering by said iron member.

9. The soldering apparatus according to claim 8, further comprising
means for adjusting a temperature of said pre-heating to an arbitrary temperature.

10. The soldering apparatus according to claim 8, wherein
said iron member is manually handled to move.
